(19) United States
(12) Patent Application Publication
(10) Pub. No.: US 2018/0093340 A1
(43) Pub. Date: Apr. 5, 2018

(54) SOLDERING DEVICE AND SOLDERING SYSTEM

(71) Applicant: ERSA GMBH, WERTHEIM (DE)

(72) Inventor: Richard Kressmann, Zell am Main (DE)

(73) Assignee: ERSA GMBH, WERTHEIM (DE)

(21) Appl. No.: 15/716,576

(22) Filed: Sep. 27, 2017

(30) Foreign Application Priority Data
Oct. 5, 2016 (DE) 10 2016 118 788.7

(51) Int. Cl. B23K 1/08; B23K 3/06; B23K 3/08

(52) U.S. Cl. CPC B23K 1/085; B23K 3/082; B23K 3/0653

(57) ABSTRACT

A soldering device, particularly solder pots for selective wave soldering or a fluxer device, having a receiving means configured to store a liquid, particularly a solder reservoir, configured to store a solder, particularly a liquid solder, or having a flux tank configured to store flux, with a nozzle, particularly a solder nozzle or fluxer nozzle, and having a pump, particularly a solder pump or a flux pump, configured to deliver the liquid from the receiving means through the nozzle in the direction of a Z-axis.

### CROSS-REFERENCE TO RELATED APPLICATIONS

This application claims priority to German patent application No. 102016118788.7, filed on Oct. 5, 2016, the entire disclosure of each of which is incorporated herein by reference.

### BACKGROUND OF THE INVENTION

The invention relates to a soldering device, particularly a solder pot for selective wave soldering or a fluxer device, having a receiving means configured to store a liquid, particularly a solder reservoir, configured to store a solder, particularly a liquid solder, or having a flux tank configured to store flux, with a nozzle, particularly a solder nozzle or fluxer nozzle, and having a pump, particularly a solder pump or a flux pump, configured to deliver the liquid from the receiving means through the nozzle in the direction of a z-axis.

Such soldering devices or solder pots are widely known from prior art. Solder pots known from prior art typically comprise a high overall weight of about 40 kg and a comparatively large volume. Such comparatively large solder pots for selective wave soldering have so far only been moved in the working area of a soldering system for selective wave soldering using known axle drives. It is known, for example, to use a belt drive, a spindle drive, a gear rack/bevel drive, or a linear motor or direct linear drive. On the one hand, these axle drives are comparatively expensive. On the other hand, use of these axle drives and the comparatively large volume of the solder pans considerably limits the field of application of the solder pans and soldering systems, such that the use of known soldering systems is comparatively “inflexible”. Increased flexibility is useful and desired, however, due to the ever-increasing variety of circuit boards to be soldered and components to be soldered and due to a reduction in batch size down to 1. The known solder pots and soldering systems cannot be used for such processing, particularly in narrow working areas.

It is therefore the problem of the invention to provide a soldering device, particularly a solder pot or fluxer device, and a soldering system which can be produced cost-effectively and can be used flexibly.

### SUMMARY OF THE INVENTION

This problem is solved by a soldering device comprises a moving device that is disposed on the soldering device and configured for independent movement of the soldering device in a working area. Advantageously, the moving device is configured for independent movement of the soldering device in a X/Y plane, that is, in a plane orthogonal to the z-axis.

According to a first advantageous further development of the soldering device, the soldering device comprises a top part and a bottom part, wherein said top part can be detachably coupled to the bottom part and comprises the receiving means and the nozzle, wherein a delivery duct of the pump is disposed in the top part, which at least in some sections extends along a circular path, and wherein a device for generating a moving magnetic field of the solder pump, which device includes at least one magnet, particularly at least one permanent magnet, and is configured such that said magnet is moved along said delivery duct, is disposed in the bottom part. It has proved particularly advantageous that the moving device is particularly disposed on the bottom part. It is particularly advantageous that the delivery duct comprises an inlet and an outlet, wherein the inlet is fluidly connected to the receiving means and wherein the outlet is fluidly connected to the nozzle. In this way, liquid, particularly liquid solder, can be delivered from the receiving means to the nozzle using the pump that is formed by the delivery duct and the device for generating a magnetic field. It is further advantageous to provide a coupling device configured for detachable coupling of the top part and the bottom part. Said coupling device advantageously includes a bayonet closure and/or a magnetic closure.

It is further conceivable that the soldering device includes a heating device which is at least partially disposed in the bottom part and configured to heat the receiving means, particularly a solder reservoir. In this way, a solder stored in the solder reservoir can be liquefied.

In another advantageous embodiment of the soldering device, the moving means comprises a carriage that is disposed on the soldering device, wherein at least one wheel is provided that is connected to said carriage. The soldering device can thus be self-propelled.

It has proved particularly advantageous to provide a driving device configured to drive at least one wheel. It is conceivable that the driving device is designed, for example, as an electric motor, pneumatic motor, or the like.

Advantageously, the moving device comprises a plurality of wheels. For example, three wheels can be provided on the circumference of the soldering device, arranged evenly across the circumference in the area of the bottom part that faces away from the nozzle. It is conceivable that the driving device is configured for driving the wheels jointly and/or separately. In addition, the moving device can be configured such that each of the wheels can be separately linkable, such that all wheels of the soldering device can be independently driven and steered. Advantageously, the moving device comprises a steering device configured for independent steering of one or more wheels. For example, it is conceivable that the steering device comprises a drive, particularly an electric motor and a transmission, wherein said drive can activate a steering gear configured to deflect the wheels into a deflected position.

According to another advantageous embodiment, it is conceivable that the moving device comprises a drive portion that is at least partially made of a ferromagnetic material, wherein said drive portion is disposed in the area of a bottom of the soldering device that is facing away from the nozzle. If the moving device has at least one such drive portion, the soldering device can for example be used in a soldering system that comprises a device for generating a traveling magnetic field, wherein said device is configured to generate a traveling magnetic field in a X/Y plane of the machine table. By generating a traveling magnetic field, the drive portion made of ferromagnetic material and with it the entire solder pot can be displaced in the X/Y plane within the soldering system, that is, orthogonally to the outlet direction of the nozzle or to the Z-direction.

In another advantageous embodiment of the soldering device, the soldering device has an overall weight of about 0.5 kg to about 5 kg, preferably of about 1 kg to about 3.5 kg. This allows, on the one hand, a reduction of a driving power of the drive that drives the soldering device or of the drives that drive the soldering device, respectively, wherein due to the comparatively low weights of the soldering devices, supporting the soldering devices on a machine table can on the other hand be achieved using an air cushion or a magnetic levitation device, such that the soldering devices can be supported on the machine table with little or almost no friction.

Furthermore, it is advantageous to provide a feed device configured to move the nozzle along the Z-axis. The feed device can be used to move the solder nozzle of a solder pot relative to a circuit board to be worked on from a resting position into a soldering position. It is conceivable that the feed device can be driven electrically. It is particularly advantageous if the feed device can be activated by a central control unit of a soldering system, such that individual solder pots can be included in, and excluded from, a running soldering program of a soldering system.

The problem mentioned above is further solved by a soldering system having at least one soldering device that comprises a machine table with a working area. The working area can substantially comprise an area located in a X/Y plane, particularly the machine table arranged in an X/Y plane, wherein this X/Y plane is orthogonal to the Z-axis. A travel path of a soldering program can be implemented by moving a soldering device that is designed as a solder pot.

Advantageously, the soldering system comprises a control unit, which is configured to control the moving device of the at least one soldering device. It has proved to be particularly advantageous that the control unit is configured to control the feed devices of the individual soldering devices. Consequently, such a control unit can be used, on the one hand, to control the moving devices of the soldering devices designed as solder pots for moving in the X/Y plane along a travel path defined by a soldering program, wherein activation of the feed devices, on the other hand, allows including the solder pots in, or excluding the solder pots from, a respective soldering program.

It has proved particularly advantageous to provide a position detecting device configured to detect the position of the at least one soldering device in the working area. Advantageously, the position detecting device is configured to transmit position data, which include information about the respective position of each soldering device of the soldering system, to the control unit.

It is particularly conceivable that the position detecting device includes at least one sensor, which is configured to detect the position of the soldering device in the working area, and/or that the position detecting device includes a laser and/or a camera. All devices or apparatuses can be used as position detecting device that are suitable to be used for automated distance and/or position detection of objects.

In another particularly advantageous embodiment of the soldering system, the soldering system comprises at least one device for generating a traveling magnetic field, wherein said device is configured to generate a traveling magnetic field in a X/Y plane of the machine table. If the moving device of the soldering device comprises a drive portion which is at least partially made of a ferromagnetic material, wherein said drive portion is disposed in the area of a bottom of the soldering device that is facing away from the nozzle, the device for generating a traveling magnetic field can be used to generate a traveling magnetic field in the X/Y plane of the machine table, wherein the respective drive portion and the soldering device connected to said drive portion can be moved in the X/Y plane by moving the traveling magnetic field. By generating a traveling magnetic field, the drive portion made of ferromagnetic material and with it the entire soldering device can be displaced in the X/Y plane within the soldering system, that is, orthogonally to the nozzle or to the Z-direction.

Advantageously, at least one power transmission device is provided that is configured to transmit electric power to the at least one soldering device. It is conceivable that the power transmission device is configured for wired or wireless power transmission of electric power to the at least one soldering device.

Particularly for wireless power transmission, the power transmission device can be configured for inductive or capacitive power transmission.

For mounting the soldering device in the soldering system as frictionless as possible, in particular on a machine table of the soldering system, at least one overpressure generator can be provided that is configured to generate a pressurized gas, wherein at least one outlet nozzle can be disposed in the machine table of the soldering system, wherein said overpressure generator is fluidly connected to the at least one outlet nozzle. Advantageously, a plurality of outlet nozzles is provided, such that pressurized gas flowing out of the outlet nozzles can produce an air cushion on the machine table. It is further possible to provide a pressure accumulator that is configured to store an inert pressurized gas, for example, nitrogen (N₂). But it is also conceivable that the soldering devices themselves comprise an overpressure generator that is configured to produce a pressurized gas, wherein at least one outlet nozzle can be disposed in the bottom part of the soldering device, such that pressurized gas flowing out of the outlet nozzles of the soldering device can produce an air cushion relative to the machine table.

### BRIEF DESCRIPTION OF THE DRAWINGS

Further details and advantageous developments of the invention can be derived from the description below, in which various embodiments of the invention described and explained in more detail.

Wherein:

FIG. 1 is a perspective view of a first embodiment of the soldering system according to the invention;

FIG. 2 is a side view of a second embodiment of the soldering system according to the invention;

FIG. 3 is a top view of the second embodiment according to FIG. 2;

FIG. 4 is a schematic side view of a soldering device according to the invention;

FIG. 5 is a schematic view of a portion of the soldering device according to FIG. 4; and

FIG. 6 is a top view of the soldering device according to FIG. 4.

### DETAILED DESCRIPTION

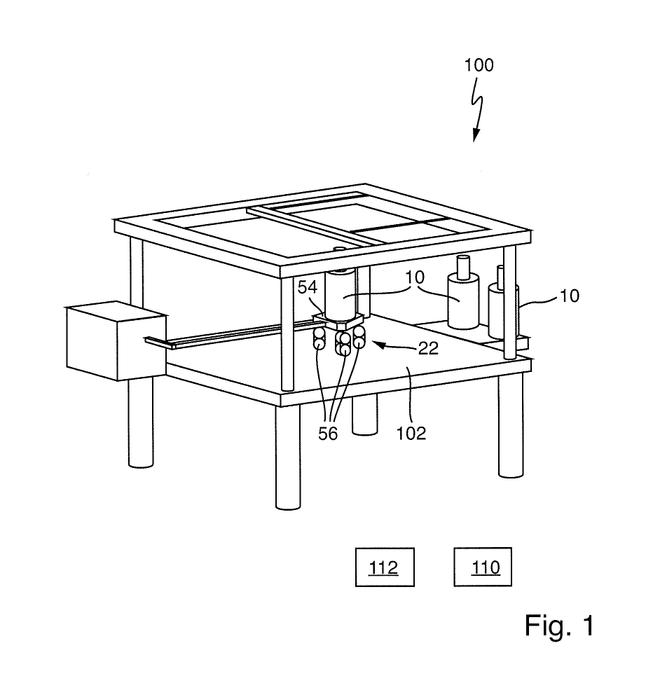

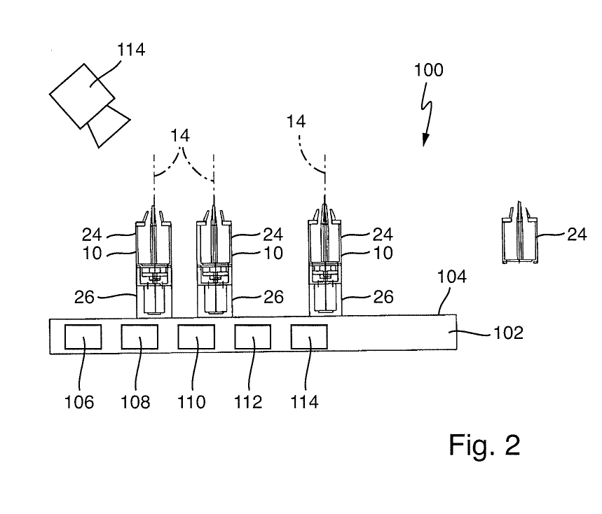

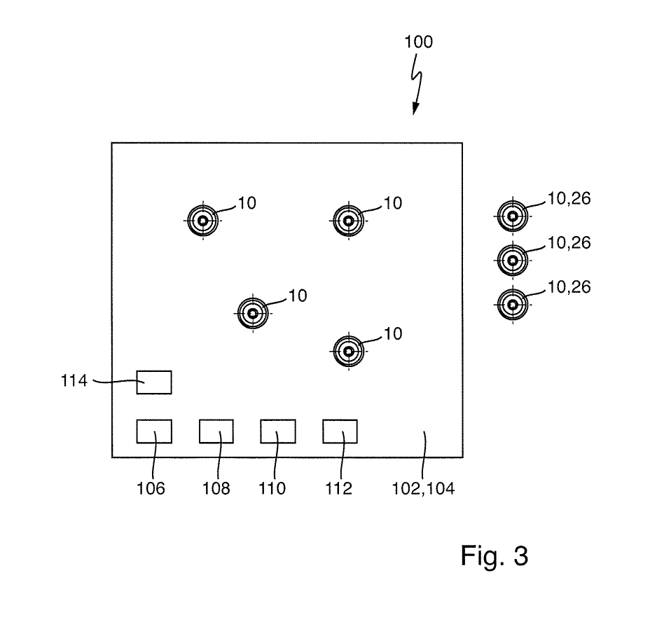

FIG. 1 shows a perspective view of a first embodiment of a soldering device 100 according to the invention, wherein FIG. 2 shows a side view of a second embodiment of a soldering device 100 according to the invention, a top view of which is shown in FIG. 3.

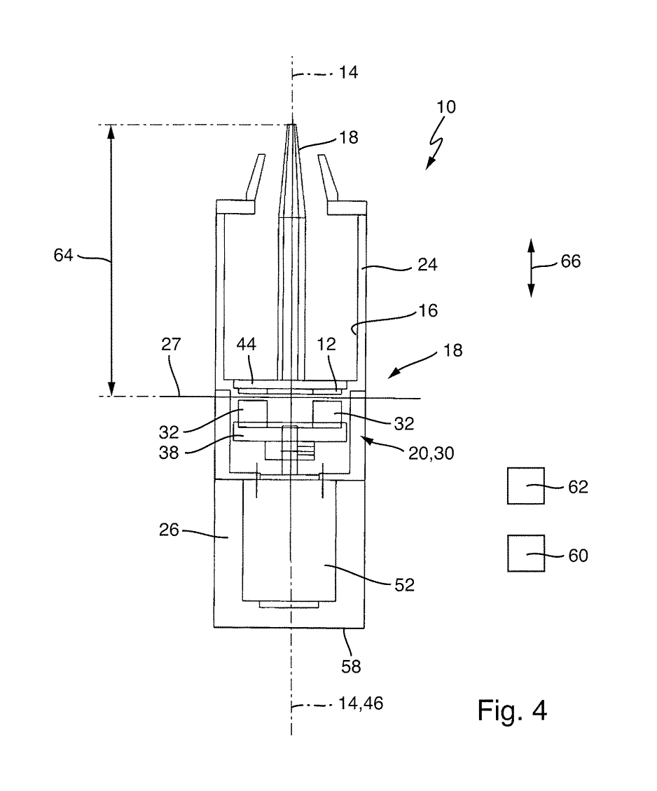

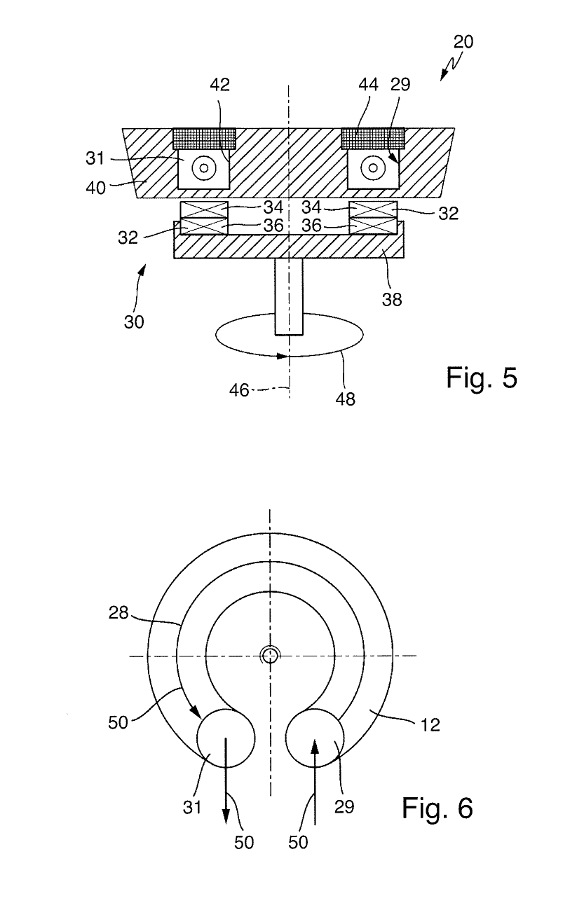

FIG. 4 shows a schematic side view of a soldering device according to the invention that is designed as a solder pot 10, particularly a solder pot for selective wave soldering, wherein FIG. 5 shows an enlarged schematic view of a portion of the solder pot 10 according to FIG. 4. FIG. 6 further shows a delivery duct 12 of the solder pot 10 according to FIG. 4. Corresponding components and elements in the figures are identified by corresponding reference symbols.

The soldering systems 100 shown in FIGS. 1 to 3 each include at least one solder pot 10 as shown in FIGS. 4 and 5. The soldering systems 100 comprise a machine table 102 with a working area. The working area substantially can comprise an area located in a X/Y plane 104, wherein said X/Y plane is orthogonal to a Z-axis 14 (see FIG. 4). A travel path of a soldering program can be implemented by moving the solder pot 10.

The solder pots 10, which are particularly designed as solder pots for selected wave soldering, comprise the solder reservoir 16 shown in FIG. 4, which is configured to store a solder, particularly a liquid solder. The solder pots 10 further comprise a solder nozzle 18 and a solder pump 20, which are configured to deliver the solder from the solder reservoir 16 through the solder nozzle 18 in the direction of the Z-axis 14.

The solder pots 10 further comprise a moving device 22 disposed on the solder pot 10 and configured to independently move the solder pot 10 in the working area, particularly for independent moving of the solder pot 10 in the X/Y plane 104, that is, in a plane orthogonal to the Z-axis 14.

As can clearly be seen in FIGS. 2 and 4, the solder pots 10 comprise a top part 24 and a bottom part 26, wherein said top part 24 can be detachably coupled to said bottom part 26 and comprises the solder reservoir 16 and the solder nozzle 18. A coupling device not shown in the figures and configured to detachably couple the top part 24 and the bottom part 26 can be provided for detachable coupling of the top part 24 and the bottom part 26. It is conceivable, for example, that the coupling device includes a bayonet closure and/or a magnetic closure. It is also possible to select a different kind of friction and/or positive locking connection. The top part 24 and the bottom part 26 can be detached from one another in the area of a parting plane 27 schematically shown in FIG. 4. The delivery duct 12 of the solder pump 20, at least some sections of which extend along a circular path 28 (see FIG. 6) and which comprises an inlet 29 and an outlet 31 is disposed in the top part 24, wherein the inlet 29 is fluidly connected to the solder reservoir 16 and wherein the outlet 31 is fluidly connected to the solder nozzle 18.

A device for generating a traveling magnetic field 30 of the solder pump 20, which includes at least one permanent magnet 32, is disposed in the bottom part 26. The device for generating a traveling magnetic field 30 is configured such that the permanent magnet 32 is moved along the delivery duct 28 when in operation.

In the solder pot 10 according to FIGS. 4 to 6, the device 30 includes a plurality of permanent magnets 32 which are facing the delivery duct 12 alternately with different magnetic poles 34, 36.

The permanent magnets 32 are arranged along a circular magnet path not shown in the figures, which is concentric with the circular path 28 of the delivery duct 12, wherein one permanent magnet 32 is disposed with its south pole 34 upwards, i.e. facing the delivery duct 12, and the adjacent permanent magnet 32 is disposed with its north pole 36 upwards, respectively. The permanent magnets 32 are mounted onto a magnet disk 38 in FIG. 5, which disk can also clearly be seen in FIG. 4.

As can be seen in FIGS. 4 and 5, the delivery duct 12 is bounded by a non-ferromagnetic material 40 into which a groove 42 is cut. This groove 42 is closed by a ring 44 made of ferromagnetic material, wherein the delivery duct 12 as a whole is bounded by the non-ferromagnetic material 40 and the ferromagnetic ring 44.

The device 30 for generating a traveling magnetic field is further configured such that, when in operation, the permanent magnets 32 rotate about an axis of rotation 46 that is concentric with the circular path 28 or the circular magnet path. When the permanent magnets 34 that are disposed below the delivery duct 12 are rotated axially (parallel to the axis of rotation 46), a traveling magnetic field can be generated in the delivery duct 12 that forms between the magnetic or ferromagnetic material 44 and the permanent magnets 32. Eddy currents can be produced in an electrically conductive fluid, particularly in a liquid solder, by the traveling magnetic field when the solder pump 20 of the solder pot 10 is in operation. By producing the eddy currents, the electrically conductive fluid or liquid solder can be accelerated in a direction of rotation indicated by the arrow 48 in FIG. 5 or by the arrows 50 in FIG. 6 along the delivery duct 12, at least some sections of which extend along the circular path 28, such that a pumping effect of the solder pump 20 can be provided.

The solder pump 20 comprises an electric motor 52, schematically shown in FIG. 4, for driving the magnet disk 38, which motor drives the magnet disk 38 or the permanent magnets 32, respectively, such that they rotate about the axis of rotation 46.

Since the top part 24 is detachably coupled with the bottom part 26 and comprises the solder reservoir 16 and the solder nozzle 18, the components of the solder pot 10 that are subject to increased wear can easily be replaced.

The moving device 22 shown in FIG. 1 is advantageously disposed on the bottom part 26 and comprises a carriage 54 that is disposed on the solder pot 10, wherein a plurality of wheels 56 is provided, each of which wheels are connected with the carriage 54. The solder pots 10 are designed to be self-propelling. The solder pots 10 shown in FIG. 1 further comprise a driving device not shown in the figures, which is configured to drive the wheels 56. It is conceivable that the driving device is designed, for example, as an electric motor, pneumatic motor, or the like. It is conceivable that the driving device is configured for driving the wheels 56 jointly and/or separately. In addition, the moving device 22 can be configured such that each of the wheels 56 can be separately linkable, such that all wheels 56 of the solder pot 10 can be independently driven and steered. The driving device 22 advantageously comprises a steering device not shown in the figures, which is configured for independent steering of the wheels 56. For example, it is conceivable that the steering device comprises a drive, particularly an electric motor and a transmission, wherein said drive can activate a steering gear configured to deflect the wheels 56 into a deflected position.

In the embodiment according to FIGS. 2 and 3, the solder pots 10 shown in FIGS. 4 to 6 have a different moving device 22. This moving device 22 comprises a drive portion which is at least partially made of a ferromagnetic material and disposed in the area of a bottom 58 of the solder pot 10 that is facing away from the solder nozzle 18. The soldering system 100 shown in FIGS. 2 and 3 comprises a device 106 for generating a traveling magnetic field, wherein said device is configured to generate a traveling magnetic field 106 in the X/Y plane 104 of the machine table 102. By generating a traveling magnetic field, the drive portion made of ferromagnetic material and with it the entire solder pot 10 can be displaced in the X/Y plane within the soldering system 100, that is, orthogonally to the solder nozzle 18 or to the Z-axis 14.

The soldering system 100 further comprises at least one overpressure generator 108 that is configured to generate a pressurized gas, wherein a plurality of outlet nozzles not shown in the figures is disposed in the machine table 102 of the soldering system 100, wherein said overpressure generator 108 is fluidly connected to the outlet nozzles, such that pressurized gas flowing out of the outlet nozzles can generate an air cushion on the machine table. It is conceivable that nitrogen (N₂) is used as pressurized gas, wherein this inert pressurized gas can then be conducted to the solder nozzles 18 using pressurized gas lines disposed in the solder pots 10.

The solder pots 10 have an overall weight of about 0.5 kg to about 5 kg, preferably of about 1 kg to about 3.5 kg. This allows, on the one hand, a reduction of the driving power of the drives that drive the solder pots 10. Due to the comparatively low weights of the solder pots 10, supporting the solder pots 10 on the machine table 102 can on the other hand be achieved using an air cushion or, alternatively, a magnetic levitation device, such that the solder pots 10 can be supported on the machine table 102 with little or almost no friction.

The solder pots 10 further comprise a heating device 60 shown in FIG. 4 for liquefying the solder stored in the solder reservoir 16, which heating device is at least partially disposed in the bottom part 26 and configured to heat the solder reservoir 16.

Furthermore, the solder pots 10 comprise a feed device 62 configured for relative displacement of the solder nozzle 18 along the Z-axis 14. The feed device 62 can particularly be configured for adjusting a distance 64 between the solder nozzle 18 and the bottom part 26, such that a type of Z-axis drive in the direction of the double-headed arrow 66 can be implemented. The feed device 62 can be used to move the solder nozzle 18 of a solder pot 10 relative to a circuit board to be worked on from a resting position into a soldering position. It is conceivable that the feed device 62 can be driven electrically.

Advantageously, the soldering system 100 comprises a control unit 110, which is configured to control the moving devices 22 of the solder pots 10. The control unit 110 is further configured to control the feed devices 62 of the individual solder pots. Consequently, such a control unit 110 can be used, on the one hand, to control the moving devices 22 of the solder pots 10 for moving in the X/Y plane 104 along a travel path defined by a soldering program, wherein activation of the feed devices 62, on the other hand, allows including the solder pots 10 in, or excluding them from, a respective soldering program.

The soldering system 100 further comprises a position detecting device 112, which is configured to detect the position of the solder pots 10 in the working area 102. The position detecting device 112 is configured to transmit position data, which include information about the respective position of each solder pot 10 of the soldering system 100, to the control unit 110 and comprises at least one sensor that is configured to detect the position of the solder pots 10 in the working area 102.

It is further conceivable that the position detecting device 112 includes a laser and/or a camera 114. All devices or apparatuses can be used as position detecting device 112 that are suitable to be used for automated distance and/or position detection of objects.

To transmit power to each solder pot 10, the soldering system 100 comprises a power transmission device 114 that is configured to transmit electric power to the solder pots 10. It is conceivable that the power transmission device 114 is configured for wired or wireless transmission of electric power to the solder pots 10, wherein said power transmission device 114 can for example be configured for inductive or capacitive power transmission.

What is claimed is:

1. A soldering device, particularly a solder pot for selective wave soldering or a fluxer device, having a receiving means configured to store a liquid, particularly a solder reservoir that is configured to store a solder, particularly a liquid solder, or having a flux tank configured to store flux, with a nozzle, particularly a solder nozzle or a fluxer nozzle, and having a pump, particularly a solder pump or a flux pump, that is configured to deliver the liquid from the receiving means through the nozzle in the direction of a z-axis, characterized in that the soldering device comprises a moving device that is disposed on the soldering device and configured for independent movement of the soldering device in a working area.

2. The soldering device according to claim 1, wherein the soldering device comprises a top part and a bottom part, wherein said top part can be detachably coupled to the bottom part and comprises the receiving means and the nozzle, wherein a delivery duct of the pump is disposed in the top part, which at least in some sections extends along a circular path, and wherein a device for generating a moving magnetic field of the solder pump, which device includes at least one magnet, and is configured such that said magnet is moved along said delivery duct, is disposed in the bottom part.

3. The soldering device according to claim 1, wherein the moving means comprises a carriage that is disposed on the soldering device, wherein at least one wheel is provided that is connected to said carriage.

4. The soldering device according to claim 3, wherein a driving device is provided that is configured to drive the at least one wheel.

5. The soldering device according to claim 3, wherein the moving device comprises a plurality of wheels.

6. The soldering device according to claim 1, wherein the moving device comprises a drive portion that is at least partially made of a ferromagnetic material, wherein said drive portion is disposed in the area of a bottom of the soldering device that is facing away from the nozzle.

7. The soldering device according to claim 1, wherein the soldering device has an overall weight of about 0.5 kg to about 5 kg, preferably of about 1 kg to about 3.5 kg.

8. The soldering device according to claim 2, wherein a feed device is provided that is configured for relative movement of the nozzle along the Z-axis.

9. A soldering system, comprising (100) including at least one soldering device (10) according to at least one of the preceding claims, wherein the soldering system (100) comprises a machine table (102) with a working area; and at least one soldering device having a receiving means configured to store a liquid, particularly a solder reservoir that is configured to store a solder, particularly a liquid solder, or having a flux tank configured to store flux, with a nozzle, particularly a solder nozzle or a fluxer nozzle, and having a pump, particularly a solder pump or a flux pump, that is configured to deliver the liquid from the receiving means through the nozzle in the direction of a z-axis, characterized in that the soldering device comprises a moving device that is disposed on the soldering device and configured for independent movement of the soldering device in a working area.

10. The soldering system according to claim 9, wherein a control unit is provided that is configured to activate the moving device of the at least one soldering device.

11. The soldering system according to claim 9, wherein a position detecting device is provided that is configured to detect the position of the at least one soldering device in the working area.

12. The soldering system according to claim 11, wherein the position detecting device includes at least one sensor that is configured to detect the position of the soldering device in the working area, and/or wherein the position detecting device includes a laser and/or a camera.

13. The soldering system according to claim 9, wherein the soldering system comprises at least one device for generating a traveling magnetic field, wherein said device is configured to generate a traveling magnetic field in a X/Y plane of the machine table.

14. The soldering system according to claim 9, wherein at least one power transmission device is provided that is configured to transmit electric power to the at least one soldering device.

15. The soldering system according to claim 14, wherein the power transmission device is configured for inductive or capacitive power transmission.

16. The soldering system according to claim 9, wherein at least one overpressure generator is provided that is configured to generate a pressurized gas, wherein at least one outlet nozzle can be disposed in the machine table of the soldering system, wherein said overpressure generator is fluidly connected to the at least one outlet nozzle.
